(19) United States
(12) Patent Application Publication
(10) Pub. No.: US 2010/0195120 A1
(43) Pub. Date: Aug. 5, 2010

(54) PUNCHING DEVICE AND IMAGE FORMING APPARATUS

(75) Inventor: Masashi KADOKURA, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/548,973

(22) Filed: Aug. 27, 2009

(30) Foreign Application Priority Data
Feb. 5, 2009 (JP) 2009-025251

(51) Int. Cl. G06F 15/00

(52) U.S. Cl. 358/1.4

(57) ABSTRACT

A punching device according to an exemplary embodiment of the present invention includes a conveying member that conveys a recording medium, a punching member that is provided with a blade to punch a hole or partial hole in the recording medium, and which can be moved to a first position where the blade punches all of the periphery of a portion of the recording medium and a punched piece is separated from the recording medium, or to a second position where the blade punches a part of the periphery of a portion of the recording medium and a partially punched piece remains connected to the recording medium, and a moving member that moves the punching member to the first position or the second position.

### CROSS-REFERENCE TO RELATED APPLICATION

This application is based on and claims priority under 35 USC 119 from Japanese Patent Application No. 2009-025251 filed Feb. 5, 2009.

### BACKGROUND

1. Technical Field

The present invention relates to a punching device and an image forming apparatus including the punching device.

2. Related Art

In a printing system having a punching mechanism that punches a fastening hole, when a punching process by the punching mechanism is designated, a reduction process is executed on printing data with a predetermined reduction ratio, and printing is performed based on reduction printing data that is obtained by the reduction process.

### SUMMARY

The present invention provides a punching device that can punch a hole in a recording medium where an image is formed, thereby preventing missing of the image, and an image forming apparatus including the punching device.

According to a first aspect of the invention, a punching device includes a conveying member that conveys a recording medium; a punching member that is provided with a blade to punch a hole or partial hole in the recording medium, and which can be moved to a first position where the blade punches all of the periphery of a portion of the recording medium and a punched piece is separated from the recording medium, or to a second position where the blade punches a part of the periphery of a portion of the recording medium and a partially punched piece remains connected to the recording medium; and a moving member that moves the punching member to the first position or the second position.

### BRIEF DESCRIPTION OF THE DRAWINGS

Exemplary Embodiments of the present invention will be described in detail based on the following figures, wherein:

FIG. 1 is a diagram illustrating an appearance of an image forming apparatus according to a first exemplary embodiment;

FIG. 2A is a schematic diagram illustrating the main configuration of a punching device according to the first exemplary embodiment;

FIG. 2B is a schematic diagram illustrating the main configuration of the punching device according to the first exemplary embodiment;

FIG. 3A is a schematic diagram illustrating the case where a punching portion is moved to a first position in accordance with the first exemplary embodiment;

FIG. 3B is a diagram illustrating recording paper where a circular hole is punched;

FIG. 4A is a schematic diagram illustrating the case where the punching portion is moved to a second position in accordance with the first exemplary embodiment;

FIG. 4B is a diagram illustrating recording paper where a circular hole is punched;

FIG. 5 is a schematic diagram illustrating the case where the punching device according to the first exemplary embodiment folds a partially punched piece;

FIG. 6 is a block diagram illustrating the main configuration of an electrical system of the image forming apparatus according to the first exemplary embodiment;

FIG. 7 is a flowchart illustrating processes of a punching program according to the first exemplary embodiment;

FIG. 8 is a flowchart illustrating processes of a punching program according to a second exemplary embodiment;

FIG. 9A is a schematic diagram illustrating the main configuration of a punching device according to a third exemplary embodiment;

FIG. 9B is a schematic diagram illustrating the main configuration of the punching device according to the third exemplary embodiment;

FIG. 10 is a flowchart illustrating processes of a punching program according to the third exemplary embodiment;

FIG. 11 is a diagram illustrating a shape of a blade that punches a hole having a rectangular shape in accordance with another exemplary embodiment;

FIG. 12A is a diagram illustrating recording paper where a hole having a rectangular shape is punched in accordance with another exemplary embodiment;

FIG. 12B is a diagram illustrating recording paper where a hole having a rectangular shape is punched in accordance with another exemplary embodiment;

FIG. 13A is a diagram illustrating a shape of a blade according to another exemplary embodiment;

FIG. 13B a diagram illustrating a shape of a blade according to another exemplary embodiment;

FIG. 14A is a diagram illustrating the main configuration of a punching device according to another exemplary embodiment;

FIG. 14B is a diagram illustrating the main configuration of a punching device according to another exemplary embodiment; and

FIG. 14C is a diagram illustrating the main configuration of a punching device according to another exemplary embodiment.

### DETAILED DESCRIPTION

Hereinafter, exemplary embodiments of the present invention will be described in detail with reference to the accompanying drawings.

### First Exemplary Embodiment

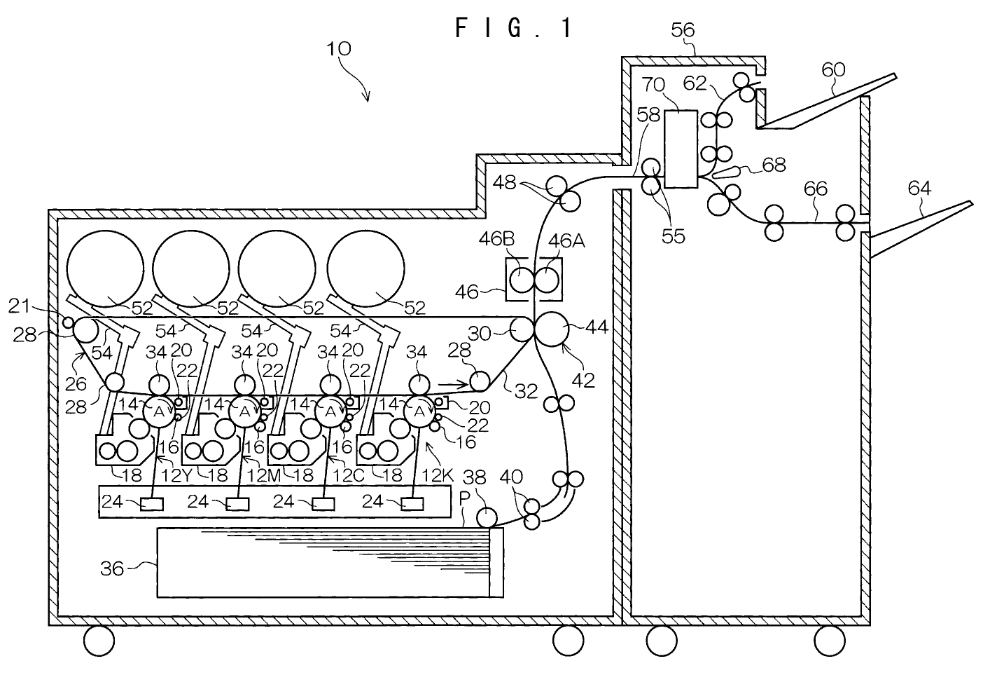

FIG. 1 shows the configuration of an image forming apparatus 10 according to the exemplary embodiment.

The image forming apparatus 10 includes image forming units 12Y, 12M, 12C, and 12K that form toner images for individual colors including yellow (Y), magenta (M), cyan (C), and black (K). Hereinafter, when the YMCK colors need to discriminate from each other, any one of Y, M, C, and K is added to the back of each reference numeral and the description is given. When the YMCK colors do not need to discriminate from each other, Y, M, C, and K are omitted.

Each of the image forming units 12 includes a photosensitive drum 14 that can be rotated by a driving mechanism (not shown). Around the photosensitive drum 14, a charging device 16, a developing device 18, a cleaning device 20, and a discharging device 22 are disposed.

A surface of the photosensitive drum 14 is charged by the charging device 16 while the photosensitive drum 14 rotates in a direction shown by an arrow A of FIG. 1 by the driving mechanism (not shown). In addition, the photosensitive drum 14 is exposed by an exposing device 24 that is provided below the image forming unit 12, and an electrostatic latent image based on image data is formed on the surface of the photosensitive drum 14. The electrostatic latent image is developed by a toner of the developing device 18, and a toner image is formed on the surface of the photosensitive drum 14. The toner image is transferred to an intermediate transfer belt 32 between a transfer roller 34 (which will be described in detail below) and the photosensitive drum 14. The toner that remains on the surface of the photosensitive drum 14 without being transferred to the intermediate transfer belt 32 after the transfer of the toner image is removed by the cleaning device 20. In addition, the surface of the photosensitive drum 14 is discharged by the discharging device 22 and is then charged by the charging device 16.

Meanwhile, on the image forming units 12Y, 12M, 12C, and 12K, an intermediate transfer object 26 is provided. The intermediate transfer object 26 includes plural winding rolls 28, a back-up roll 30, and the endless intermediate transfer belt 32 that is wound to the plural winding rolls 28 and the back-up roll 30. The photosensitive drum 14 comes into contact with the intermediate transfer belt 32, and a transfer roller 34 is provided at a position that faces the photosensitive drum 14 with the intermediate transfer belt 32 therebetween.

The image forming units 12Y, 12M, 12C, and 12K are serially arranged in this order with respect to a proceeding direction of the intermediate transfer belt 32, and toner images that are formed in the individual image forming units 12 and have colors different from each other are transferred to the intermediate transfer belt 32 to overlap each other. As a result, color toner images are formed on the intermediate transfer belt 32.

Meanwhile, on a bottom portion of the image forming apparatus 10, a paper storage portion 36 where recording paper P is stored is provided. A front end of the recording paper P, which is stored in the paper storage portion 36, in a conveyance direction (hereinafter, referred to as “paper conveyance direction) comes into contact with a feeding roller 38. The individual recording paper P is fed from the paper storage portion 36 to the downstream side of the paper conveyance direction, by means of the feeding roller 38 and a paper separating mechanism (not shown). Further, on the downstream side of the paper conveyance direction of the feeding roller 38, two sets of conveying rollers 40 are disposed. The recording paper P is conveyed to an upper transfer portion 42 by the conveying rollers 40.

The transfer portion 42 includes the back-up roll 30 and a secondary transfer roll 44 that is welded in pressure to the back-up roll 30 through the intermediate transfer belt 32. In addition, when the recording paper P passes through the transfer portion 42 (nip portion of the back-up roll 30 and the secondary transfer roll 44), the color toner image on the intermediate transfer belt 32 is transferred to the recording paper P.

On the upper side of the transfer portion 42 and the downstream side of the paper conveyance direction, a fixing portion 46 is disposed. The fixing portion 46 has a heating roller 46B and a pressure belt 46A that is welded in pressure to the heating roller 46B. When the recording paper P passes through a nip portion of the heating roller 46B and the pressure belt 46A, the toner is melt, solidified, and fixed on the recording paper P. In addition, the recording paper P is conveyed to a post-processing device 56 by a conveying roller 48 that is provided on the paper conveyance direction downstream side of the fixing portion 46.

Further, the toner that is not transferred to the recording paper P by the transfer portion 42 and remains on the intermediate transfer belt 32 is collected by an intermediate transfer object cleaning device 21 that is disposed on the intermediate transfer belt 32.

On the intermediate transfer object 26, toner cartridges 52 where individual color toners are stored are provided. The toner is supplied from the toner cartridge 52 to the developing device 18 by a toner conveying mechanism 54 in accordance with necessity.

Further, the toner cartridge 52 can be attached to or detached from the image forming apparatus 10. If the toner does not remain in the toner cartridge 52, the existing toner cartridge 52 can be exchanged with a new toner cartridge 52 where a toner is stored.

The post-processing device 56 includes a conveying path 58 that conveys the recording paper P, which is conveyed by the conveying roller 48, in an approximately horizontal direction by means of the conveying roller 55.

The conveying path 58 is branched into a conveying path 62 that is linked to a paper tray 60 and a conveying path 66 that is linked to a paper tray 64 provided below the paper tray 60. A conveying path of the recording paper P that is conveyed along the conveying path 58 is switched by a gate 68 provided in a branching portion.

Further, in the post-processing device 56 according to the exemplary embodiment, on the upstream side of the paper conveyance direction more than the branching portion of the conveying path 58, a punching device 70 that executes a punching process to punch a hole (so-called punch hole) at a predetermined position of the recording paper P is provided.

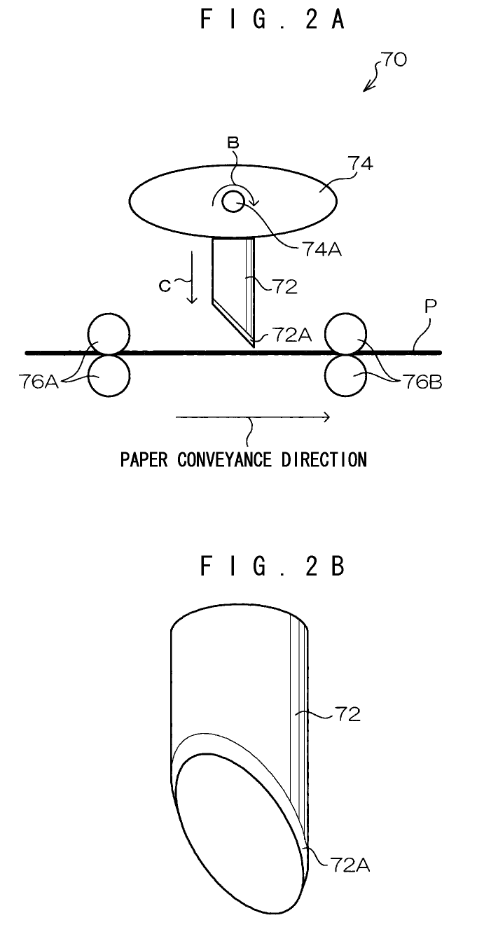

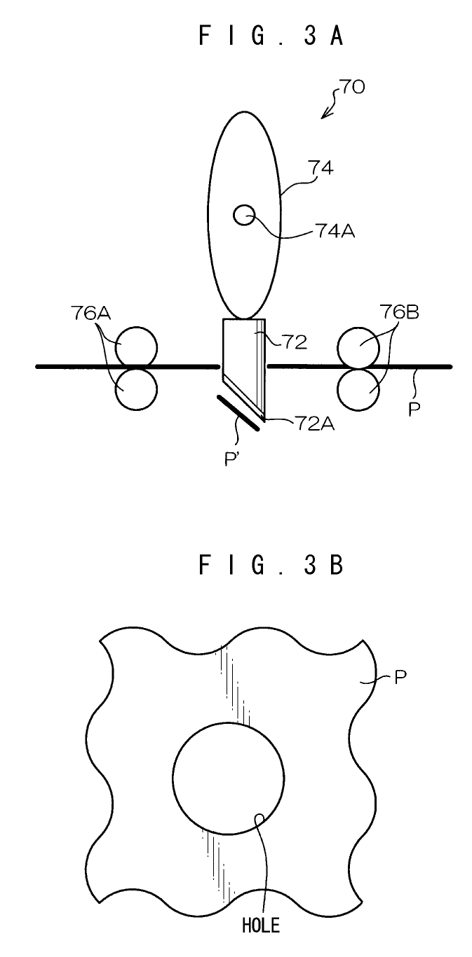

FIGS. 2A and 2B show the configuration of the punching device 70.

As shown in FIG. 2A, the punching device 70 according to the exemplary embodiment includes a punching portion 72 that is provided with a blade 72A to punch a hole, a cam 74 that moves the punching portion 72, and conveying rollers 76A and 76B that convey the recording paper P. In FIG. 2A, in order to avoid intricacy, only one punching portion 72 is shown, however, the punching device 70 may have plural punching portions 72.

As shown in FIG. 2B, the punching portion 72 according to the exemplary embodiment is a tube member that has a cylindrical shape. In the punching portion 72, a front end is formed in the blade 72A to punch a hole in the recording paper P and has a wedge shape. Further, the punching portion 72 is disposed such that the sharp side of the wedge shape is located at the downstream side of the paper conveyance direction.

The cam 74 according to the exemplary embodiment is formed in an elliptical shape, and a central shaft 74A thereof is juncturally connected to a driving device (not shown) and rotated in a direction shown by an arrow B in FIG. 2A. If the cam 74 rotates, the punching portion 72 moves in a direction shown by an arrow C of FIG. 2A that is a direction approximately vertical with respect to the recording paper P. Further, when a hole is not punched in the recording paper P, the cam 74 is rotated to an angle at which the major axis is parallel to the recording paper P.

In addition, in accordance with a rotation angle of the cam 74, the punching portion 72 according to the exemplary embodiment can be moved to a first position where all of the periphery of the hole is punched and a punched piece P′ is separated from the recording paper P, and a second position where a part of the periphery of the hole is punched and the partially punched piece P′ remains connected to the recording paper P. That is, the first position is a position where the blade 72A penetrates the recording paper P, and the second position is a position where the blade 72A does not penetrate the recording paper P.

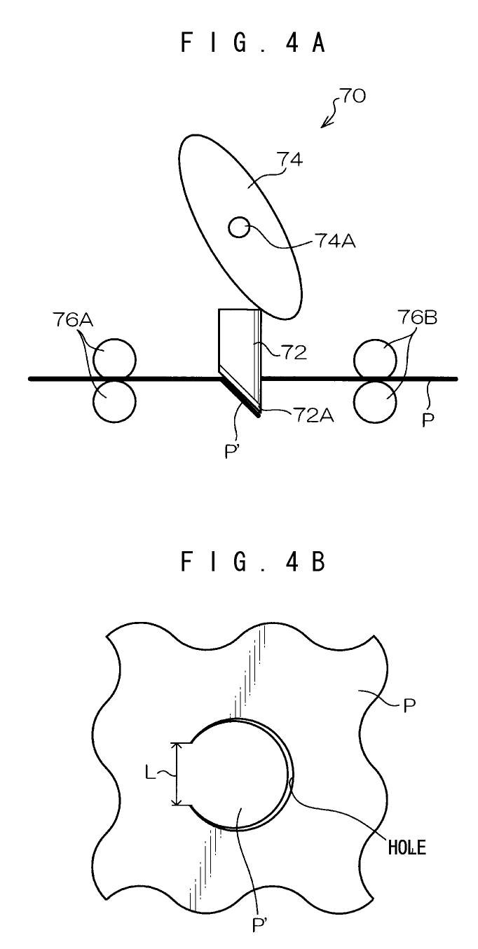

FIG. 3A shows the case where the punching portion 72 is moved to the first position and a hole is punched.

In the image forming apparatus 10 according to the exemplary embodiment, the cam 74 is rotated to an angle at which the major axis of the cam 74 is vertical with respect to the recording paper P, such that the blade 72A penetrates the recording paper P, thereby punching a circular hole in a state where the punched piece P′ is separated from the recording paper P, as shown in FIG. 3B. Further, the rotation angle of the cam 74 may be an angle where the blade 72A penetrates the recording paper P, and does not need to be the angle in which the major axis of the cam 74 is vertical with respect to the recording paper P.

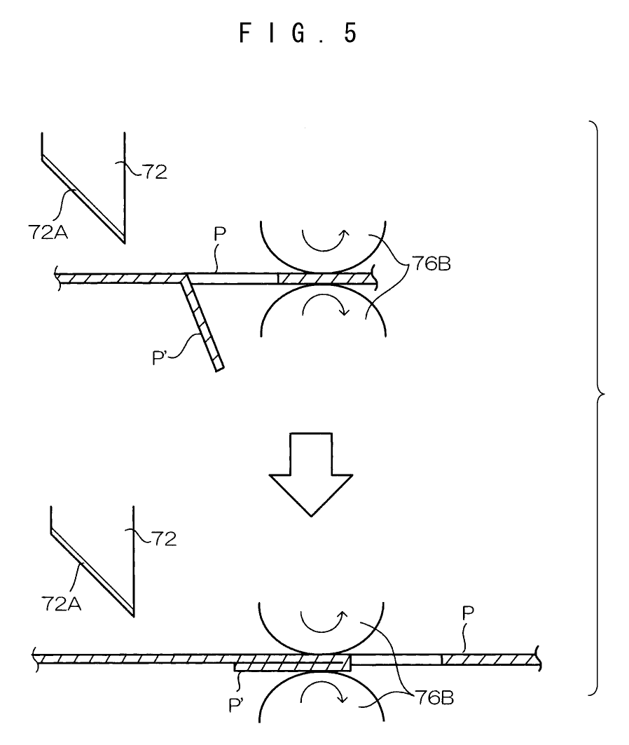

FIG. 4A shows the case where the punching portion 72 is moved to the second position and a hole is punched.

In the image forming apparatus 10 according to the exemplary embodiment, the cam 74 is rotated to an angle smaller than the angle at which the major axis of the cam 74 is vertical with respect to the recording paper P, such that the blade 72A does not penetrate the recording paper P, thereby punching a circular hole in a state where the partially punched piece P′ remains connected to the recording paper P, as shown in FIG. 4B.

As described above, the punching portion 72 is disposed such that the sharp side of the wedge shape is located at the downstream side of the paper conveyance direction. Therefore, a portion where the partially punched piece P′ and the recording paper P remain connected to each other becomes the upstream side of the paper conveyance direction.

Further, a length L where the partially punched piece P′ and the recording paper P remain connected to each other varies in accordance with the rotation angle of the cam 74. For example, when a material of the recording paper P is stiff, the length L is shortened in order to easily bend the partially punched piece P′. Meanwhile, when the material of the recording paper P is soft or an important image is formed on the recording paper P, the length L is lengthened in order to make the separation of the punched piece P′ from the recording paper P difficult. That is, in accordance with the material of the recording paper P and the contents of the image formed on the recording paper P, the rotation angle of the cam 74 may be controlled.

Further, when the recording paper P reaches the predetermined position (hereinafter, referred to as “process position”) where a punching process is executed, the image forming apparatus according to the exemplary embodiment stops the recording paper P conveyed by the conveying rollers 76A and 76B. If the punching process with respect to the recording paper P is completed, the image forming apparatus restarts the conveyance of the recording paper P by the conveying rollers 76A and 76B.

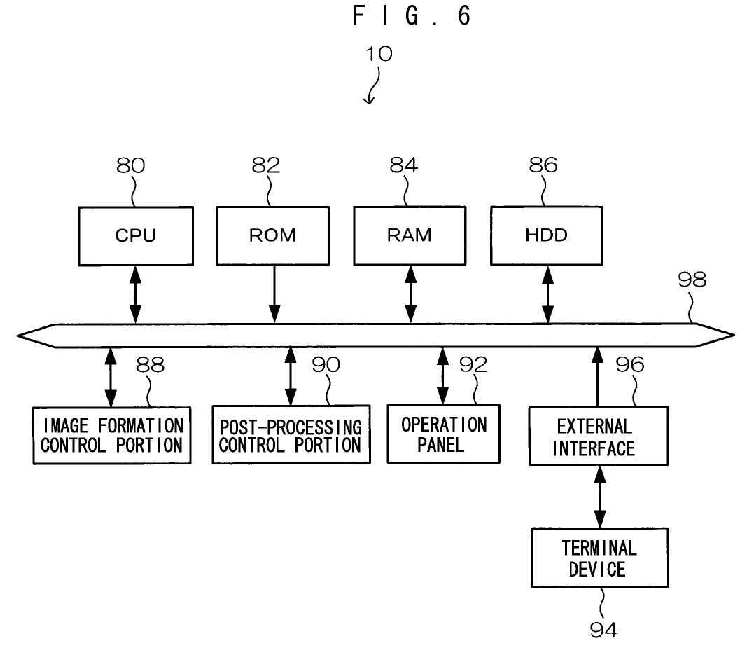

Further, the conveying roller 76B according to the exemplary embodiment is disposed on the downstream side of the paper conveyance direction more than the conveying roller 76A. Therefore, as shown in FIG. 5, the recording paper P, which is conveyed after the punching process and to which the partially punched piece P′ remains connected, is folded.

FIG. 6 shows the main configuration of an electrical system of the image forming apparatus 10 according to the exemplary embodiment.

The image forming apparatus 10 includes a CPU (Central Processing Unit) 80 that performs the entire operation of the image forming apparatus 10, a ROM (Read Only Memory) 82 where various programs, various parameters, and various table information are stored in advance, a RAM (Random Access Memory) 84 that is used as a work area, when the various programs are executed by the CPU 80, and an HDD (Hard Disk Drive) 86 that stores image information received by an external interface 96 (which will be described in detail below) or various information.

Further, the image forming apparatus 10 includes an image forming control portion 88 that is connected to the control objects, such as the image forming unit 12, the exposing device 24, and the fixing portion 46, which are used for processes of forming an image (hereinafter, referred to as “image forming process”) with respect to the recording paper P, and controls driving of the individual control objects, a post-processing control portion 90 that controls driving of the post-processing device 56, an operation panel 92 that is provided with an operation button or a ten-key where various operation instructions are input and a display to display various messages, and the external interface 96 that is connected to an external terminal device 94, and transmits and receives information including image information indicating an image formed on the recording paper P or an image forming execution signal to execute an image forming process based on the image information, between the external terminal device 94 and the external interface 96.

The CPU 80, the ROM 82, the RAM 84, the HDD 86, the image forming control portion 88, the post-processing control portion 90, the operation panel 92, and the external interface 96 are electrically connected to each other through a system bus 98. Accordingly, the CPU 80 can have access to the ROM 82, the RAM 84, and the HDD 86, grasp an operation state or display various massages with respect to the operation panel 92, control the operations of the image forming control portion 88 and the post-processing control portion 90, and transmit and receive a variety of information with the terminal device 94 through the external interface 96.

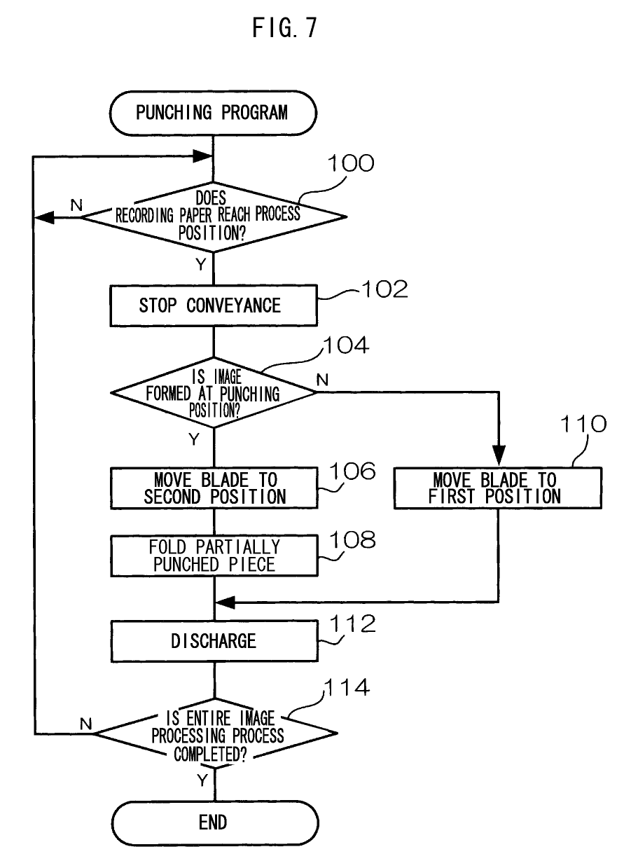

Next, with reference to FIG. 7, the operation of the image forming apparatus 10 according to the exemplary embodiment will be described. FIG. 7 is a flowchart illustrating processes of a punching program that is executed by the CPU 80, when an execution instruction of an image forming process including a punching process to punch a hole in the recording paper P is input from the operation panel 92 or the terminal device 94. In this case, the punching program is stored in advance in a predetermined area of the ROM 82 that serves as a recording medium.

First, in Step 100, a waiting state is maintained until the recording paper P reaches a process position where the punching process is executed.

Further, in the image forming apparatus 10 according to the exemplary embodiment, a sensor is used to determine whether the recording paper P reaches the process position, however, the invention is not limited thereto. For example, a time necessary for the recoding paper P to reach the process position after starting formation of an image may be measured in advance, and whether or not the recording paper P has reached the process position may be determined based on the time.

Next, in Step 102, the conveyance of the recording paper P is stopped by controlling the post-processing control portion 90 to stop the conveying rollers 76A and 76B.

Next, in Step 104, it is determined whether an image is formed at a position on the recording paper P where a hole is to be punched (hereinafter, referred to as “punching position”). If it is determined that an image is formed, the procedure proceeds to Step 106. If it is determined that an image is not formed, the procedure proceeds to Step 110.

Further, in the image forming apparatus 10 according to the exemplary embodiment, based on the coordinates of the punching position of the recording paper P and the coordinates indicating an area of the recording paper P where an image is formed, it is determined whether an image is formed at the punching position.

In Step 106, the punching portion 72 is moved to the second position, and the post-processing control portion 90 is controlled to punch a partial hole such that the partially punched piece P′ remains connected to the recording paper P.

Next, in Step 108, the post-processing control portion 90 is controlled to restart the conveyance of the recording paper P by the conveying rollers 76A and 76B, thereby folding the partially punched piece P′ by the conveying roller 76B, and the procedure proceeds to Step 112.

In Step 110, the punching portion 72 is moved to the first position and the post-processing control portion 90 is controlled to punch a hole such that the punched piece P′ is separated from the recording paper P, and the procedure proceeds to Step 112.

In Step 112, the post-processing control portion 90 is controlled to discharge the recording paper P to the paper tray 60 or the paper tray 64.

Next, in Step 114, it is determined whether the entire image forming process is completed. If it is determined the entire image forming process is not completed, the procedure returns to Step 100. If it is determined that the entire image forming process is completed, the program ends.

### Second Exemplary Embodiment

In the second exemplary embodiment, an example where a user selects to separate the punched piece P′ from the recording paper P or remain the partially punched piece P′ connected to the recording paper P will be described. In the second exemplary embodiment, the configuration of the image forming apparatus 10, the configuration of the punching device 70, and the configuration of the electrical system of the image forming apparatus 10 are the same as those in the first exemplary embodiment (refer to FIGS. 1, 2, and 6). Therefore, the repetitive description will be omitted.

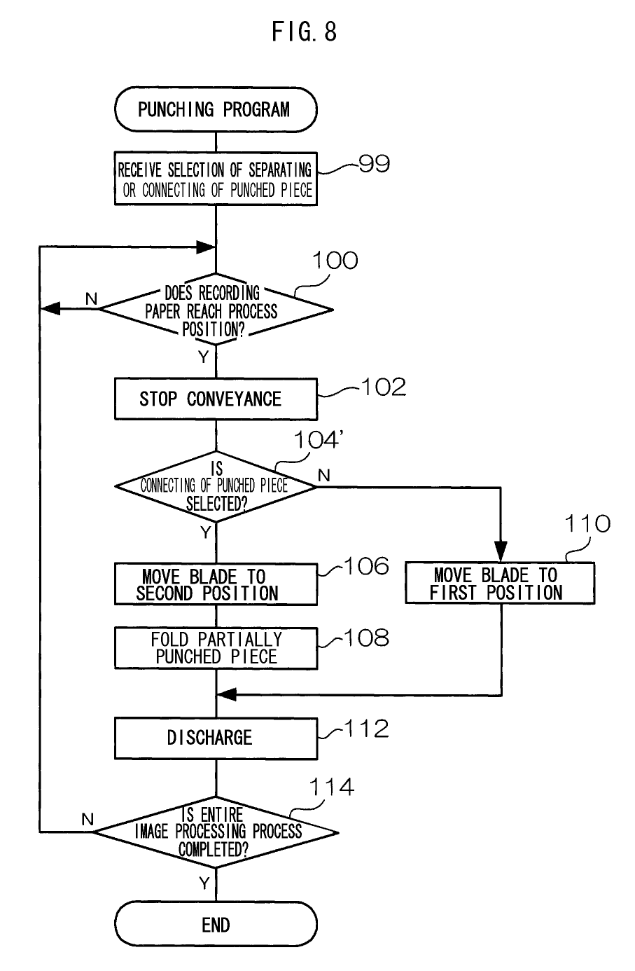

Next, with reference to FIG. 8, the operation of the image forming apparatus 10 according to the second exemplary embodiment will be described. FIG. 8 is a flowchart illustrating processes of a punching program that is executed by the CPU 80, when an execution instruction of an image forming process including a punching process to punch a hole in the recording paper P is input from the operation panel 92 or the terminal device 94. In this case, the punching program is stored in advance in a predetermined area of the ROM 82 that serves as the recording medium. Further, with respect to Steps where the same processes as the flowchart of FIG. 7 in the first exemplary embodiment are executed, the same reference numerals as those in FIG. 7 will be denoted, and the repetitive description will be omitted.

First, in Step 99, after receiving the selection from the user indicating to separate the punched piece P′ from the recording paper P or remain the partially punched piece P′ connected to the recording paper P, the procedure proceeds to Step 100.

Further, in the image forming apparatus 10 according to the second exemplary embodiment, the selection from the user is received by the operation panel 92 or the terminal device 94. Specifically, after the execution instruction of the image forming process including the punching process to punch a hole in the recording paper P is input, a selection screen that receives the selection is displayed on the operation panel 92 or the display of the terminal device 94 to which the execution instruction is input. Further, in the image forming apparatus 10 according to the second exemplary embodiment, the image forming process starts after the selection is completed.

In Step 104′, it is determined by the process of Step 99 whether connection of the punched piece P′ to the recording paper P is selected. If it is determined that the connection of the punched piece P′ to the recording paper P is selected, the procedure proceeds to Step 106, and the post-processing control portion 90 is controlled to move the punching portion 72 to the second position. If it is determined that the connection of the partially punched piece P′ to the recording paper P is not selected, the procedure proceeds to Step 110, and the post-processing control portion 90 is controlled to move the punching portion 72 to the first position.

### Third Exemplary Embodiment

In the third exemplary embodiment, an example where the image forming apparatus further includes a pushing member that pushes out the punched piece P′ which is connected to the recording paper P will be described. In the third exemplary embodiment, the configuration of the image forming apparatus 10 and the configuration of the electrical system of the image forming apparatus 10 are the same as those in the first exemplary embodiment (refer to FIGS. 1 and 6). Therefore, the repetitive description will be omitted.

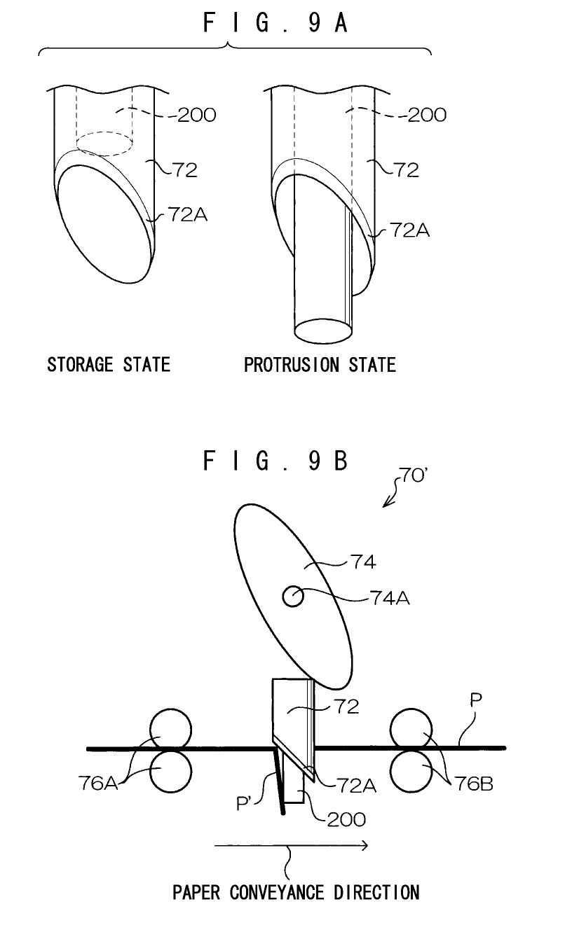

FIGS. 9A and 9B show the configuration of a punching device 70′ according to the third exemplary embodiment. In FIGS. 9A and 9B, the same constituent elements as those in FIG. 2A will be denoted by the same reference numerals as those in FIG. 2A, and the repetitive description will be omitted.

The punching device 70′ according to the third exemplary embodiment includes a pushing member 200 at an inner portion which is a hollow space in the punching portion 72.

As shown in FIG. 9A, the pushing member 200 is either in a storage state, in which the pushing member 200 is stored such that it does not protrude beyond the front end of the punching portion 72, or a protrusion state in which the pushing member 200 protrudes beyond the front end of the punching portion 72. When the punching portion 72 punches the recording paper P at the second position, the pushing member 200 is in the protruding state in order to push out the partially punched piece P′ which is connected to the recording paper P, as shown in FIG. 9B.

Further, in the image forming apparatus 10 according to the third exemplary embodiment, a columnar shape is applied as a shape of the pushing member 200, however, the invention is not limited thereto. A cylindrical shape, a polygonal shape, and other shapes may be applied as the shape of the pushing member 200.

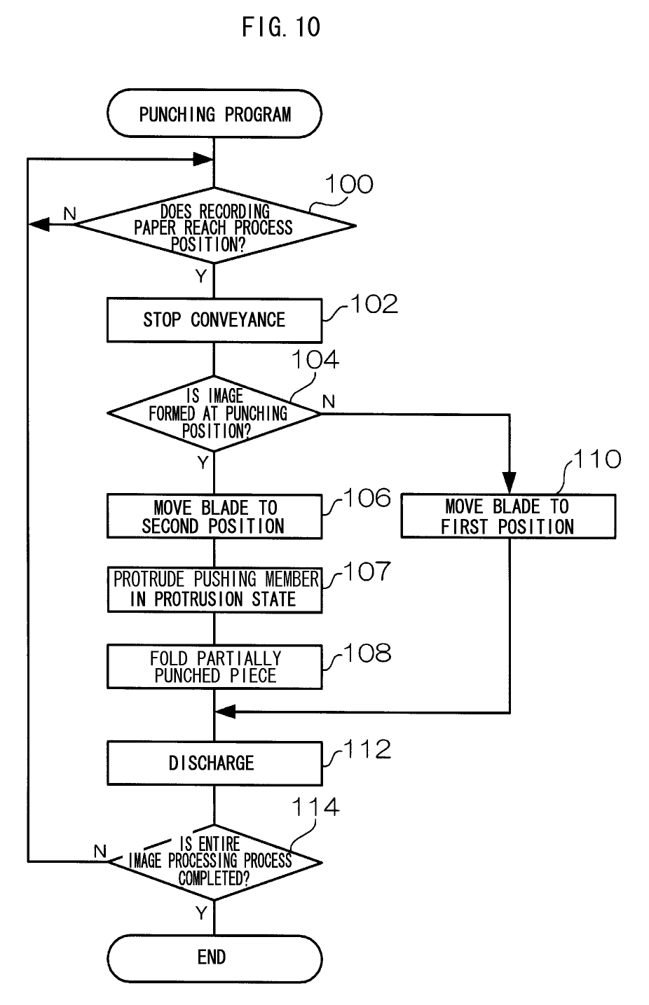

Next, with reference to FIG. 10, the operation of the image forming apparatus 10 according to the third exemplary embodiment will be described. FIG. 10 is a flowchart illustrating processes of a punching program that is executed by the CPU 80, when an execution instruction of an image forming process including a punching process to punch a hole in the recording paper P is input from the operation panel 92 or the terminal device 94. In this case, the punching program is stored in advance in a predetermined area of the ROM 82 that serves as the recording medium. Further, with respect to Steps where the same processes as the flowchart of FIG. 7 in the first exemplary embodiment are executed, the same reference numerals as those in FIG. 7 will be denoted, and the repetitive description will be omitted.

First, in Step 106, the punching portion 72 is moved to the second position, and the post-processing control portion 90 is controlled to punch a partial hole such that the partially punched piece P′ remains connected to the recording paper P. Then, the procedure proceeds to Step 107.

In Step 107, the pushing member 200 is put in the protrusion state and the post-processing control portion 90 is controlled to push out the partially punched piece P′, and then the procedure proceeds to Step 108, where the post-processing control portion 90 is controlled to restart the conveyance of the recording paper P by the conveying rollers 76A and 76B.

The invention has been described using the exemplary embodiments, however, the technical range of the invention is not limited to the range that is described in the exemplary embodiments. Various changes and modifications can be made in the exemplary embodiments in a range that does not depart from the concept of the invention. Of course, the various changes and modifications can be included in the technical range of the invention.

Further, the exemplary embodiments do not limit the invention that is related to claims, and all of the combinations of the characteristics that are described in the exemplary embodiments are not essential in the means for resolving the invention. The inventions of various stages are included in the exemplary embodiments, and the various inventions can be extracted by combinations of plural disclosed essential conditions. Even though some essential conditions are deleted from the essential conditions that are disclosed in the exemplary embodiments, the configuration where some essential conditions are deleted can be extracted as the invention, as long as the same effect can be obtained.

For example, in the exemplary embodiments, a case in which the post-processing device 56 includes the punching portion 72 has been described; however, the invention is not limited thereto. In addition to the punching portion 72, the post-processing device 56 may include a leaflet creation portion that superposes and binds a set number of plural recording papers P and folds the recording papers P into two or more sections, a stapling portion that superposes the set number of plural recording papers P and staples a predetermined position of the superposed recording papers P, and a folding portion that folds the recording papers P from one to Z times, according to a set folding method.

Further, in the exemplary embodiments, the case where the punching portion 72 punches the circular hole has been described, however, the invention is not limited thereto. The punching portion 72 may punch a hole that has a polygonal shape.

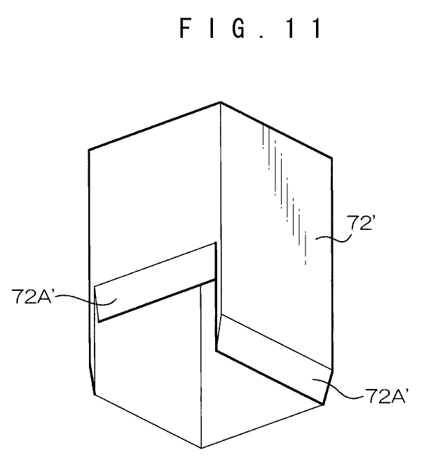

An example of the above form is shown in FIG. 11. A punching portion 72′ shown in FIG. 11 has a quadrangular prismatic shape and a blade 72A′ is formed at a front end of each side. However, one blade 72A′ is formed higher than the other three blades 72A′.

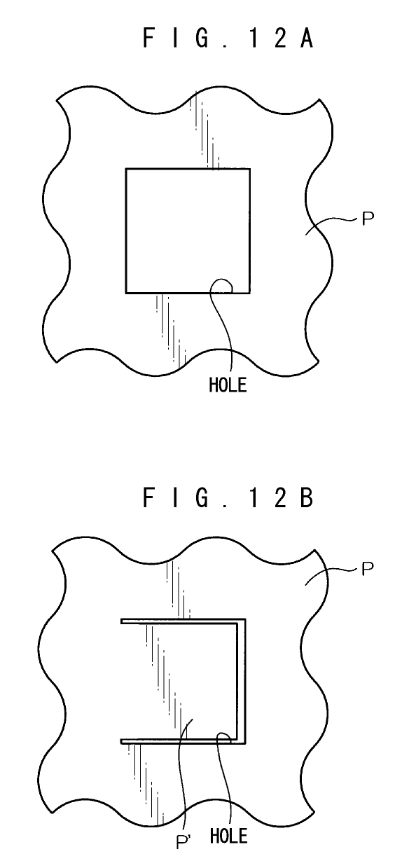

That is, in this case, the position where the recording paper P is punched by all of the blades 72A′ formed at the four sides corresponds to the first position. If the punching portion 72′ is moved to the first position and the recording paper P is punched, a rectangular hole where the punched piece P′ shown in FIG. 12A is separated from the recording paper P is punched. Meanwhile, the position where the recording paper P is punched by the blades 72A′ formed at the three sides corresponds to the second position. If the punching portion 72′ is moved to the second position and the recording paper P is punched, a rectangular hole in a state where one side of the punched piece P′ shown in FIG. 12B remains connected to the recording paper P is punched. Even in this case, the punching portion 72′ is disposed such that one side of the partially punched piece P′ remains connected to the recording paper P at the upstream side of the paper conveyance direction.

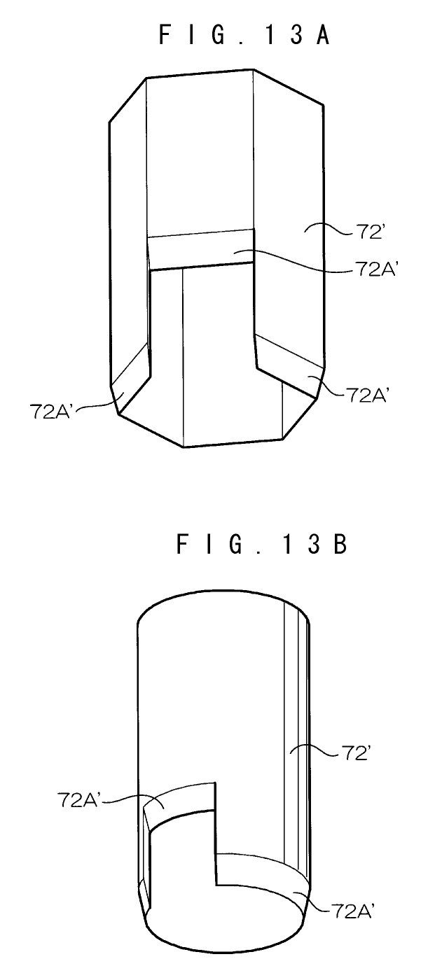

Further, the shape of the punching portion 72′ may be other polygonal shape, such as a hexagonal prismatic shape where one blade 72A′ of is formed higher than the other sides of the blades 72A′, as shown in FIG. 13A, and the shape of the hole may be a polygonal shape, such as a triangular shape, a pentagonal shape, and a hexagonal shape. Further, the shape of the punching portion 72′ may be a cylindrical shape where a portion of the blade 72A′ is formed higher than the other, as shown in FIG. 13B.

Further, in the exemplary embodiments, the case where the punching portion 72 is moved to the first position or the second position using one cam 74 has been described, however, the invention is not limited thereto. The punching portion 72 may be moved to the first position or the second position using the two cams 74.

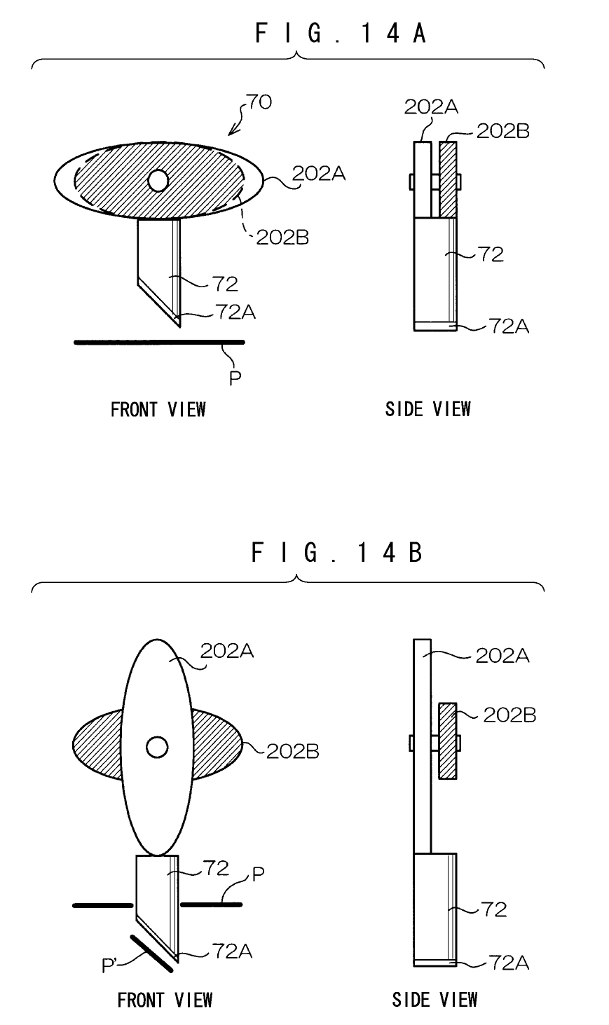

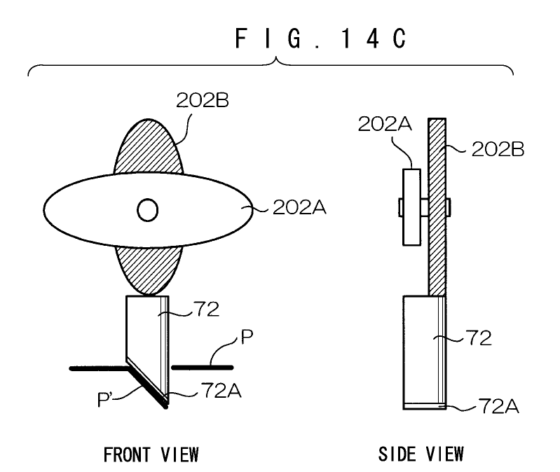

An example of the above form is shown in FIGS. 14A to 14C. A punching device 70′ shown in FIGS. 14A to 14C includes a cam 202A that is formed in an elliptical shape and a cam 202B which is formed in an elliptical shape and whose major axis is shorter than that of the cam 202A.

In this case, when the hole is not punched in the recording paper P by the punching portion 72, as shown in FIG. 14A, the cams 202A and 202B are rotated to an angle at which the major axes thereof are parallel to the recording paper P. When the punching portion 72 is moved to the first position, as shown in FIG. 14B, the cam 202A is rotated to an angle at which the major axis thereof is vertical with respect to the recording paper P, and the cam 202B is rotated to an angle at which the major axis thereof is parallel to the recording paper P. When the punching portion 72 is moved to the second position, as shown in FIG. 14C, the cam 202A is rotated to an angle at which the major axis thereof is parallel to the recording paper P, and the cam 202B is rotated to an angle at which the major axis thereof is vertical with respect to the recording paper P.

Further, the configuration (refer to FIGS. 1, 2, and 6) of the image forming apparatus 10 that is described in the exemplary embodiments is only exemplary, and the unnecessary portions may be deleted or new portions may be added in the range that does not depart from the concept of the invention.

Further, the processes (refer to FIGS. 7, 8, and 10) of the punching program that is described in the exemplary embodiments is also exemplary, and the unnecessary steps may be deleted, new steps may be added, or the process sequence may be changed in the range that does not depart from the concept of the invention.

Further, the punching program according to the exemplary embodiments may be stored in advance in the ROM 82, may be stored in advance in the HDD 86, may be stored in a computer readable recording medium and provided, or may be distributed through a wired or wireless communication mechanism.

What is claimed is:

1. A punching device, comprising:
a conveying member that conveys a recording medium;
a punching member that is provided with a blade to punch a hole or partial hole in the recording medium, and which can be moved to a first position where the blade punches all of the periphery of a portion of the recording medium and a punched piece is separated from the recording medium, or to a second position where the blade punches a part of the periphery of a portion of the recording medium and a partially punched piece remains connected to the recording medium; and
a moving member that moves the punching member to the first position or the second position.

2. The punching device of claim 1, further comprising:
a folding member that folds the partially punched piece which is connected to the recording medium.

3. The punching device of claim 2, further comprising:
a pushing member that pushes out the partially punched piece which is connected to the recording medium, when the recording medium is punched at the second position by the punching member.

4. The punching device of claim 3,
wherein the punching member is hollow; and
the pushing member is either in a storage state, in which the pushing member is stored such that it does not protrude beyond the front end of the punching portion, or a protrusion state in which the pushing member protrudes beyond the front end of the punching portion.

5. The punching device of claim 1,
wherein the moving member is a cam that is formed in an elliptical shape, and that moves the punching member to the first position or the second position in accordance with a rotation angle of the cam.

6. The punching device of claim 1,
wherein the moving member includes first and second cams that are each formed in an elliptical shape, and have minor axes of the same length, the major axis of the first cam being longer than the major axis of the second cam,
and the first cam can be rotated to an angle at which the major axis thereof is vertical with respect to the recording medium, thereby moving the punching member to the first position, and the second cam can be rotated to an angle at which the major axis thereof is vertical with respect to the recording medium thereby moving the punching member to the second position.

7. The punching device of claim 1,
wherein the punching member is a tube member that has a cylindrical shape, and
a front end of the punching member has a wedge shape when seen from the side, and a sharp side of the wedge shape is located at the downstream side in a conveyance direction of the recording medium.

8. The punching device of claim 1,
wherein, when the blade is shaped to punch a hole or partial hole having a polygonal shape, the recording medium is punched at the second position, and the partially punched piece is connected to the recording medium at one side of the polygonal shape.

9. The punching device of claim 1,
wherein the blade is shaped to punch a circular hole or partial hole, and a first portion of the blade is higher than a second portion of the blade.

10. The punching device of claim 1,
wherein, when an image is formed at a position of the recording medium at which a hole is to be punched, the moving member moves the punching member to the second position.

11. The punching device of claim 1, further comprising a selecting portion that selects whether to move the punching member to the first position or the second position.

12. An image forming apparatus, comprising:
the punching device of claim 1; and
an image forming portion that forms an image indicated by image information on the recording medium.
